(19) United States
(12) Patent Application Publication
(10) Pub. No.: US 2017/0020168 A1
(43) Pub. Date: Jan. 26, 2017

(54) Sweet Potato (ipomoea batatas) Liquid

(71) Applicant: CHRISTOPHER M. ARELLANO, IDAHO FALLS, ID (US)

(72) Inventor: CHRISTOPHER M. ARELLANO, IDAHO FALLS, ID (US)

(21) Appl. No.: 15/073,511

(22) Filed: Mar. 17, 2016

Related U.S. Application Data
(60) Provisional application No. 62/134,443, filed on Mar. 17, 2015.

(51) Int. Cl. A23L 2/04; A23K 20/10; A23L 2/72; A23L 19/10; A23L 2/52

(52) U.S. Cl. CPC A23L 2/04; A23L 19/105; A23L 2/52; A23L 2/72; A23K 20/10; A23V 2002/00

(57) ABSTRACT

What is disclosed is a method of maximizing the juice obtained from juicing a sweet potato by freezing and thawing the sweet potato. Sweet potatoes are considered a “super food” in today's culture due to the large number of vitamins found within sweet potatoes. At current, sweet potato juice by itself is not known to be disseminated in significant commercial quantities, which may be due to an inability to obtain commercially viable amounts of sweet potato juice with a reasonable economic expenditure. Accordingly, what is disclosed is a method of obtaining the juice economically with potential uses of the juice discussed.

### PRIORITY/CROSS-REFERENCE TO RELATED APPLICATIONS

This application claims the benefit of U.S. Provisional Application No. 62/134,443, filed Mar. 17, 2015 the disclosure of which is incorporated by reference.

### TECHNICAL FIELD

The presently disclosed technology relates to a process for the separation of sweet potato liquid from sweet potato pulp. More particularly, the present invention is a process for making a sweet potato beverage.

### BACKGROUND

Sweet potatoes are considered a superfood; however, based on complexities with bulk juicing efficiencies, sweet potato juice is not commercially available. What is needed is an economical and viable method for producing sweet potato juice from a raw sweet potato.

### SUMMARY OF THE DISCLOSURE

The purpose of the Summary is to enable the public, and especially the scientists, engineers, and practitioners in the art who are not familiar with patent or legal terms or phraseology, to determine quickly from a cursory inspection, the nature and essence of the technical disclosure of the application. The Summary is neither intended to define the inventive concept(s) of the application, which is measured by the claims, nor is it intended to be limiting as to the scope of the inventive concept(s) in any way.

This process is a method to extract sweet potato liquid, referred to also as sweet potato juice, more efficiently than traditional methods such as using a juicing machine or blender. It is thought that the sweet potato cell wall is structured in a spiral fashion. It is thought that this process weakens the spiral structure of the sweet potato by rupturing the cell wall tissue by “using” the expansive and compressive force(s) that result(s) from water-to-ice-expansion which occurs about and within the sweet potato when the sweet potato is frozen, which causes dislodgement of nutrients and displacement of cellular water within the sweet potato. Weakening of the sweet potato spiral structure by rupturing the cell wall by using expansive and compressive force of water as the water within the potato is turned into ice by freezing the sweet potato, is referred to in this application as “uncoiling.”

The expansive and compressive force of water is understood to be the descriptive term that characterizes a pressure-volume effect resulting from the thermal-dependent organization of H20 hydrogen-bonds into a more open and hexagonal lattice shape at a specific temperature and/or pressure. As uncoiling of the cell wall takes place, transport mechanisms of the sweet potato cell wall are effected as channels within the cell wall are created which allow water and nutrients to flow between the cell walls with little resistance as compared to its never-frozen coiled state, once the sweet potato is thawed after having been frozen. This allows liquid of the sweet potato to be extracted easily by pressurizing the sweet potato in order to drain the liquid volume of the sweet potato from pulp volume.

The process involves freezing the sweet potato, thawing the sweet potato, and then separating sweet potato liquid from sweet potato pulp. In a preferred embodiment, the sweet potato is frozen for the less than 48 hours. The process involves obtaining a suitable sweet potato (or a surplus of suitable sweet potatoes), washing the sweet potato, freezing the sweet potato in order to uncoil its structure, which weakens the cell wall tissue as liquid held within the sweet potato cells expands into ice causing a rupture in the cell wall, and then thawing the sweet potato to liquefy the ice back into liquid, allowing liquid to flow through the rupture cell wall tissue with less resistance as compared to a never-frozen sweet potato. The liquid can then be extracted through exit channels by applying pressure to the thawed sweet potato. The sweet potato may be segmented or perforated to increase exit channels. The end result of the process is maximum extraction of sweet potato liquid from sweet potato pulp, which can be separately contained, and both the pulp and the juice can be used as two separate edible products for commercial use. For example, the pulp can be used for hash browns, vegetable patties, vegetarian meals, and animal foodstuffs, among other things.

Theoretical Understanding of How the Freeze-Thaw-Extract Process Works

It is thought that extraction of sweet potato liquid from sweet potato pulp is maximized after a sweet potato endures several different physiological adaptations. The physiological states the sweet potato must endure are the Raw State, Freezing State, Frozen State, Thawing State, Thawed State, Separation State, and Separated State, as described below.

Raw State—Major Emphasis: Rigid Cell Wall Tissue, the Pulp, Suspends Liquid H20

This is the condition the sweet potato begins with entering the Freeze-Thaw-Extract process. In this state the sweet potato has an internal temperature above freezing and it is structured as its normal growing process designated. In the Raw State, the cell walls are arranged tightly bound to each other with fibrous connections which provide the sweet potato structural support. Liquid is held in between the cell walls along with cellular organelles, vitamins and minerals. Together, the cell walls and liquid provide a stable shape for the sweet potato as well as a stable density as each cell holds a specific volume of liquid at a given time. The stable shape and density provide the sweet potato with compression-resistant qualities and rigidity which helps to protect the sweet potato from having its internals extracted. Cellular transport mechanisms are optimal for living-growth, reproduction, and post-growth-longevity of the sweet potato. Oxidative effects are minimized by the in-tact cell wall. The sweet potato is covered by an outer layer of skin which serves to protect it against pathogen invasion, water loss, and oxidation.

Freezing State—Major Emphasis: Ice Suspends the Pulp, Pulp Suspends Liquid

The sweet potato is in the freezing state when it is placed in a freezing environment. In a freezing environment the sweet potato begins losing heat to the cold surrounding it. Heat exchange begins at the outermost surface of the sweet potato causing a gradual temperature drop that begins on the surface and makes its way inward, or deeper, toward the sweet potato's core. As the sweet potato drops below freezing it begins to freeze from outside-in, creating in the sweet potato a frozen tissue “shell” surrounding the unfrozen core. As the sweet potato freezes liquid within the cells begins to crystallize in the formation of ice, causing cellular expansion, leading to a structural rupture in the cell wall by separation. The frozen sweet potato tissue undergoes a lowering change in density. The lowered density is accompanied by a significant physiological change, that is, the cell wall now no longer suspends liquid, and instead, ice suspends the cell wall.

As the sweet potato continues to lose heat, ice formation continues to penetrate the sweet potato and the frozen tissue continues to expand via the path of least resistance. As the frozen shell thickens it becomes more and more resistant to the expansion of deeper freezing tissue and, as a result, deep ice penetration begins pressurizing the unfrozen core. The pressurized core gains resilience against freezing and the cells become tightly compressed. With this assumed, large sweet potatoes with very deep cores may require much more time and/or more intense freezing temperatures to freeze all the way to the core. It is possible that sweet potatoes, especially large sizes, would not completely freeze at high-freezing temperatures. As the freezing continues, the cell wall is gradually suspended by ice, resulting in the cell wall losing some of its supportive function.

Frozen State—Major Emphasis: Ice Suspends the Pulp Entirely

The sweet potato is frozen when ice-formation has penetrated the sweet potato down to its core. In its frozen state the entire cell wall is suspended by ice. The volume of the frozen sweet potato is understood to be larger than its raw-state volume. In this state, the density is also understood to be lower than it was in its raw-state. The frozen state sweet potato's molecules are rearranged as the raw state molecule structuring has been distorted into a frozen-state structuring. The cellular transport mechanisms of the sweet potato are inhibited by the frozen environment

Thawing State—Major Emphasis: Skin Suspends Liquid+Pulp. Ice Suspends the Pulp

In the Thawing State, the sweet potato begins to thaw from its frozen state when it is placed in an environment above freezing temperatures. Like ice penetration, heat penetration begins on the surface of the sweet potato and makes its way inward, deeper, toward the core. Heat penetration causes the ice to condense back into water from the outside-in, with respect to collective placement of ice within the sweet potato, creating a thickening shell of thawed sweet potato tissue surrounding a frozen sweet potato.

Assuming the core was pressurized during the freezing process, that pressurization at the frozen core may be relieved as the sweet potato thaws and contracts externally, given the ice is condensing into liquid on the outside of the core, which may allow room for deep frozen tissue to expand outwardly into causing the same rupturing and separation of cell wall tissue deep in the sweet potato. As thawing progresses, less and less of the cell wall tissue is suspended by ice and the cell wall tissue begins to contract towards the center of the sweet potato. The cell wall is still suspended by ice at the core of the sweet potato but now shares a structural support role with liquid in the thawed areas.

The weakened cell wall tissue recoils to its familiar shape as ice surrounding it thaws, but irreversible damage prevents it from regaining its original structural strengths and the cell wall is idealized to hold a mesh-like structure. Uncontained liquid absorbs sugars and carries with it nutrients and other cellular components that were displaced by the effects of freezing and then thawing, comprising the sweet potato liquid. Sweet potato liquid is able to pass more freely throughout the weakened cell wall of the thawed tissue. Channels of water surround bridges of cell wall tissue and this pattern repeats in a spiral fashion to the growth-origin of the sweet potato, hence the expansion/uncoil and contraction/recoil relation. The skin begins to wrinkle as contraction of the cell wall progresses

Thawed State—Major Emphasis: Skin Helps Suspend the Liquid+Pulp

Once the sweet potato has reached a high enough internal temperature to unfreeze the entire sweet potato then it is thawed. In its thawed state the sweet potato's volume is less than that of its frozen state-volume and raw state-volume. At this point the sweet potato is squishy to the touch and its geometric shape observably changes in response to a given compressive force that would comparatively and perceivably not affect the geometric shape of a similar or the same sweet potato when in its raw state, due to the raw state's rigid nature, such as force applicable by the squeezing grip of an average, healthy, adult human, as the cell wall has been distorted from the raw state by the freezing state and ice has been liquefied from its frozen state by the thawing state. The sweet potato now relies on help from the skin to provide it structural support and contain the liquid.

Sweet potato liquid is able to pass throughout channels in the cell wall tissue, also known as pulp, and may even exit the sweet potato through skin lesions. In its thawed state the potato is more susceptible to oxidation, which the skin helps to provide protection against by sealing out air. Now that the sweet potato has thawed liquid can easily be separated from the pulp by pressurizing the sweet potato or a segmented part of the sweet potato to force liquid out of exit channels in the pulp.

Separation State—Major Emphasis: Sweet Potato Liquid Separates From Sweet Potato Pulp

The thawed state sweet potato is, or segments of the thawed-state sweet potato are, pressurized to force liquid out from within the pulp via exit channels.

Separated State—Major Emphasis: Sweet Potato Liquid is One Product and the Sweet Potato Pulp is a Second Product

In this state, most of the sweet potato liquid has been forced out of the sweet potato pulp and the sweet potato liquid is contained outside of the sweet potato pulp. The moist sweet potato pulp is apart from the sweet potato liquid. The sweet potato liquid is apart from the moist sweet potato pulp.

The volume of the liquid from an ordinary sweet potato accounts for over 50% of the sweet potato. The color of the liquid is determined by the color of the flesh. If the sweet potato flesh is orange then the liquid is usually a less intense orange clouded by traces of suspended nutrients. The consistency is smooth as the liquid is naturally filtered by the pulp during extraction.

The pulp product also has several unique features such as size, storability, handle ability, edibility, low sugar, and sell ability. The pulp of the sweet potato is left largely intact after the liquid has been drained. The pulp is easy to collect and stores well in the freezer. The pulp can be used as an additive to meals or made into a meal itself. It can be flavored with sauces for a low calorie food option. Other uses for the pulp include hash browns, vegetable patties, vegetarian meals, and animal foodstuffs. The sugar content is lowered when liquid is extracted from it. The pulp can be dehydrated, powdered and sold as a filler to food companies.

The advantages of the present invention are numerous and include, but are not limited to the following:

The Freeze-Thaw-Extract process is conceivably the most efficient, quiet, safe, and low-maintenance method to separate sweet potato liquid from pulp. The process is scalable for large production of a consistent sweet potato liquid and pulp product. The freezing of the sweet potato may help to kill off any temperature-sensitive or pressure sensitive pathogens. This process has not been found to be used by any commercial beverage companies to extract sweet potato liquid with intentions for beverage production. It can be used on other vegetables, such as carrots, for a liquid suitable for beverage quality specific to the vegetable being separated.

The end-product-qualities of the Freeze-Thaw-Extract process can't be replicated by juicing machines as juicing machines use a completely different series of steps to yield liquid and pulp separation. The only commonality between machine juicing of the sweet potato and Freeze-Thaw-Extraction of the sweet potato is that they both begin with a raw sweet potato. The two processes are different and the two products they each yield are different.

Juicers extract sweet potato liquid by force feeding the raw sweet potato into a high-speed rotating grater that shreds the sweet potato into tiny pieces which fall into a spinning basket with sifted walls. As the basket spins the shreds of sweet potato spin against the basket wall, due to inertia, which allows liquid, and pulp particles small enough to fit through the sift, to exit into the juice container, while particles too big to be filtered are distributed into a separate container as pulp. Juicers are reliant on motors, blades, speed, centripetal force, inertia, and mechanized filtration.

The two end products of juicers include:

1) Sweet potato particles that went through the sifter, “the juice”.

2) Sweet potato particles that could not or did not happen to go through the sifter, “the pulp”.

The pulp left over from juices is a moist, pulverized, cell wall susceptible to oxidation, and it falls apart from other pulp particles and can be a nuisance to handle. The remaining pulp has very limited uses and much of the pulp gets caught in the basket wall. Sweet potatoes are much too fibrous to be conveniently juiced using juicers, as the metal basket walls are too delicate and fine to handle the amount of pulp a sweet potato has. The liquid product consistency may vary due to filter-plugging, blade sharpness, blade speed. Juicing machinery requires an upkeep including part replacement and small particle cleaning on surfaces and small crevices throughout the juicing machine. The mechanized juicing process is loud and may require operators use ear protection to avoid hearing damage or aggravation. Vibration caused in juicing a firm vegetable like the sweet potato is not good for the longevity of the machine, and clean-up of small particles within the machine is required repetitively as fibers are easily caught in the basket wall. This is a poor option for large-scale production.

Freeze-Thaw-Extract

In the Freeze-Thaw-Extract process a raw sweet potato is frozen solid by placing it in freezing conditions and then thawed completely by removing it from freezing conditions. Once the sweet potato is thawed it can be segmented, perforated, or left whole before applying pressure to the thawed sweet potato to separate liquid from the pulp.

The two end products of the Freeze-Thaw-Extract process include:

1) Sweet potato liquid that has been extracted from the sweet potato pulp.

2) Sweet potato pulp that has had the majority of its liquid (juice) extracted.

The Freeze-Thaw-Extract process is quiet and does not require ear protection to operators. The upkeep on equipment is relatable to keeping a freezer running and wiping down surfaces of extraction equipment that liquid flows across. The wear and tear on equipment is kept to a minimum due to the physical pace and highly efficient nature of the extraction process. Small particles are not created in this process and many sweet potatoes can be extracted with little time spent for cleanup that is necessary for liquid extraction in an efficient and consistent manner.

Notable Differences

1) The Freeze-Thaw-Extract process is anticipated to increase overall consumer value to sweet potatoes as the two products created in the process, sweet potato liquid and sweet potato pulp, can be sold separately as commercial products and/or sold separately as additions to commercial products that could conceivably not exist without the use of this process.

2) Liquid/juice extracted by both processes differs in color, consistency, texture, flavor, additive solubility, nutrient profile and the corresponding health benefits of that nutrient profile.

3) Pulp remaining from both processes differs in pulp volume, pulp particle size, handle ability, color, surface area, rate of oxidation, nutrient profile, and potential for commercial use.

The pulp product of the Freeze-Thaw-Extract process also has several unique features such as size, storability, handle ability, edibility, low sugar, and sell ability. The pulp of the sweet potato is left largely intact after the liquid has been drained. The pulp is easy to collect and stores well in the freezer. The pulp can be used as an additive to meals or made into a meal itself. It can be flavored with sauces for a low calorie food option. The sugar content is lowered when liquid is extracted from it. The pulp can be dehydrated, powdered and sold as a filler to food companies.

Sweet potato liquid as an all-natural sweet potato beverage and/or sweet potato liquid-based-energy drink. The liquid extracted by the Freeze-Thaw-Extract method has several unique features such as volume per sweet potato, flavor, natural sugars, color, suspended nutrients, and consistency. The flavor of the liquid is very sweet, so sweet that it could be used as a natural sweetener if dehydrated or simply added to other products. The liquid by itself makes a sweet beverage, which could be sold as 100% sweet potato juice and compete against other fruit or vegetable juices. The liquid could also have at least one ingredient from the list consisting of niacin, folic acid, riboflavin, cyanocobalamin, pyridoxine hydrochloride, L-carnitine, glucuronolactone, creatine, L-theanine, Ginkgo Biloba, pantothenic acid, ginseng, caffeine, guarana, green tea extract, NIAGEN®, PURENERGY™ Caffeine-pTeroPure® Co-crystal and taurine added to market it as an “energy drink”. The sweet potato liquid infused with energy ingredients is thought to be a healthier option to energy drinks such as those available on the market today, and other like-products, which use added sugar or artificial sweeteners in order to achieve sweetness.

These products may be fortified with vitamin B complexes in order to assist with cellular metabolism. Stimulants such as caffeine anhydrous, green tea extract, and taurine, are also added in order to stimulate the central nervous system which may increase cellular metabolism and cognitive functioning temporarily. Ordinarily contained amounts of caffeine in energy drinks are 140-170 mg per 15-16 ounces. These products are notorious for providing a temporary jolt of energy followed by a fatigue, or crash. This is because caffeine, with a half-life typical of 4-6 hours, blocks adenosine receptors in the brain which alert the brain of its need for rest or sleep. The blocking of adenosine increases the action of dopamine, and as adenosine levels are elevated in the blood it stimulates adrenal gland functioning which causes the release of adrenaline.

Sweet potato liquid infused with energy ingredients does not require the addition of any vitamins or minerals to give it a vitamin complex or mineral complex as it is naturally supplied with a high-nutrient profile which includes natural sugars to give it its taste. Sweet potato liquid can be infused with PurEnergy in order to distinguish itself from ordinary energy drinks considering what PurEnergy is as described in patent U.S. Pat. No. 8,399,712.

Sweet potato liquid may also be infused with Niagen to differentiate itself by utilizing the benfits Niagen has to offer as a NAD+ precursor as discussed in U.S. Pat. Nos. 8,106,184, 8,114,626, 8,197,807, 8,383,086, and 7,776,326.

It is thought that as sweet potato liquid can be formulated with more technologically advanced energy ingredients such as Niagen and PURENERGY, in addition to the list of ingredients provided above, which may make for a superior energy drink beverage. It is thought that as the Health Benefit:Purchase ratio is increased a wider variety of buyer-demographic would be interested in consuming sweet potato liquid infused with energy ingredients vs. the energy drinks already available.

Sweet potato liquid infused with one or more of the energy ingredients discussed above offers all natural flavoring, vegetable contribution to daily diet, unique flavor, no added sugars, lower-than-average caffeine mg per fluid ounce, natural nutrients plus added nutrients, unique natural nutrients such as fiber, longer lasting energy effects, metabolic efficiency assistance, antioxidants, high beta carotene, high vitamin A, and colorfully orange liquid.

Sweet potato liquid infused with one or more energy ingredients differentiates itself from currently available energy drinks because it is the only Sweet Potato energy drink; it does not rely on added sugars for flavoring; it contains all natural fiber; it is made by using the Freeze-Thaw-Extract process on a sweet potato and then adding energy ingredients to it to enhance the liquid by providing the consumer with energy boost+sweet potato vegetable liquid health benefits; and it adds to the variety of energy drinks offered in a way that promotes health benefits.

How Sweet Potato Liquid Energy Drink is Made

A sweet potato is put through the Free-Thaw-Extract process to yield sweet potato liquid and sweet potato pulp. The sweet potato liquid has at least one ingredient from the list consisting of niacin, folic acid, riboflavin, cyanocobalamin, pyridoxine hydrochloride, L-carnitine, glucuronolactone, creatine, L-theanine, Ginkgo Biloba, pantothenic acid, ginseng, caffeine, guarana, green tea extract, NIAGEN® which is thought to be nicotinamide riboside as discussed in U.S. Pat. Nos. 8,106,184, 8,114,626, 8,197,807, 8,383,086, and 7,776,326, PURENERGY™ Caffeine-pTeroPure® Co-crystal which is thought to be a combination of ˜43% Caffeine and ˜57% pTeroPure pterostilbene as discussed in U.S. Pat. No. 8,399,712, and taurine added to now market it as a sweet potato liquid-based energy drink.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

What is disclosed is a method of juicing a sweet potato and making a drink out of the sweet potato juice extracted there from. The method utilizes the step of freezing a sweet potato by placing said sweet potato in temperatures sufficient to freeze a sweet potato and leaving the sweet potato until the sweet potato is completely frozen. The sweet potato is then thawed after being allowed to freeze completely. It is thought that the time to freeze a sweet potato is 24-36 hours of being placed in a standard freezer of approximately five degrees Fahrenheit, although this could be reduced or other techniques of freezing can be utilized, such as multi-station plater forster, air-blast freezing tunnels, fluidized bed freezers, immersion freezing, and the Freeze Flo process.

After the sweet potato is completely frozen, which can be easily tested by known means, the sweet potato is thawed. In a preferred embodiment batches of sweet potato are frozen, with frozen batches being utilized to chill subsequent batches, which assists in lowering the overall energy cost needed to freeze the subsequent batch of sweet potatoes. Preferably this step will utilize a physical barrier configured to prevent pathogens from transferring between batches of sweet potatoes yet allow for thermal transfer between the batches of sweet potatoes. In a preferred embodiment the sweet potato and subsequently the juiced liquid are kept at a temperature of less than 40 degrees Fahrenheit, and preferably less than 37 degrees Fahrenheit but sufficiently high enough to prevent the extracted juice from freezing. Maintaining low temperature is preferred in order to minimize potential pathogen growth and ideally to prevent the need of further processing of the juice.

After the sweet potatoes have thawed ideally completely, the liquid is extracted from the sweet potatoes. Preferably, the liquid is extracted by utilizing a juicer (preferably a commercial juicer) to extract the sweet potato juice and leaving sweet potato pulp. This pulp can subsequently be processed for use in human and/or animal food. For example, the sweet potato pulp can be dehydrated for processing as, for example, hash browns or burger patties (such as vegan burger patties). Alternatively the pulp can be utilized as feed for animals.

After the juice has been extracted it can be directly packaged for distribution or shipped to a further processing facility for bottling and/or further processing. The sweet potato liquid extract can be pasteurized (including ultra-pasteurization) or filtered to remove potential pathogens.

The sweet potato liquid can be provided to consumers without further processing as a healthy juice or alternatively additive can be added to the juice. For example, the juice can have further vitamins and/or minerals added, caffeine, and/or further energy supplements. The juice can be formulated as an energy drink or left as “raw” sweet potato juice. For example, vitamin B12, vitamin B6, Vitamin B3, and/or taurine can be added to to the sweet potato liquid extracted from the sweet potato. Niacin, folic acid, riboflavin, cyanocobalamin, pyridoxine hydrochloride, L-carnitine, glucuronolactone, creatine, L-theanine, Ginkgo Biloba, pantothenic acid, ginseng, caffeine, guarana, and/or taurine can also be added to the sweet potato liquid extracted from said sweet potato.

### DETAILED DESCRIPTION OF THE PREFERRED EMBODIMENTS

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

What is disclosed is a method of juicing a sweet potato and making a drink out of the sweet potato juice extracted there from. The method utilizes the step of freezing a sweet potato by placing said sweet potato in temperatures sufficient to freeze a sweet potato and leaving the sweet potato until the sweet potato is completely frozen. The sweet potato is then thawed after being allowed to freeze completely. It is thought that the time to freeze a sweet potato is 24-36 hours of being placed in a standard freezer of approximately five degrees Fahrenheit, although this could be reduced or other techniques of freezing can be utilized, such as multi-station plater forster, air-blast freezing tunnels, fluidized bed freezers, immersion freezing, and the Freeze Flo process.

After the sweet potato is completely frozen, which can be easily tested by known means, the sweet potato is thawed. In a preferred embodiment batches of sweet potato are frozen, with frozen batches being utilized to chill subsequent batches, which assists in lowering the overall energy cost needed to freeze the subsequent batch of sweet potatoes. Preferably this step will utilize a physical barrier configured to prevent pathogens from transferring between batches of sweet potatoes yet allow for thermal transfer between the batches of sweet potatoes. In a preferred embodiment the sweet potato and subsequently the juiced liquid are kept at a temperature of less than 40 degrees Fahrenheit, and preferably less than 37 degrees Fahrenheit but sufficiently high enough to prevent the extracted juice from freezing. Maintaining low temperature is preferred in order to minimize potential pathogen growth and ideally to prevent the need of further processing of the juice.

After the sweet potatoes have thawed ideally completely, the liquid is extracted from the sweet potatoes. Preferably, the liquid is extracted by utilizing a juicer (preferably a commercial juicer) to extract the sweet potato juice and leaving sweet potato pulp. This pulp can subsequently be processed for use in human and/or animal food. For example, the sweet potato pulp can be dehydrated for processing as, for example, hash browns or burger patties (such as vegan burger patties). Alternatively the pulp can be utilized as feed for animals.

After the juice has been extracted it can be directly packaged for distribution or shipped to a further processing facility for bottling and/or further processing. The sweet potato liquid extract can be pasteurized (including ultra-pasteurization) or filtered to remove potential pathogens.

The sweet potato liquid can be provided to consumers without further processing as a healthy juice or alternatively additive can be added to the juice. For example, the juice can have further vitamins and/or minerals added, caffeine, and/or further energy supplements. The juice can be formulated as an energy drink or left as “raw” sweet potato juice. For example, vitamin B12, vitamin B6, Vitamin B3, and/or taurine can be added to to the sweet potato liquid extracted from the sweet potato. Niacin, folic acid, riboflavin, cyanocobalamin, pyridoxine hydrochloride, L-carnitine, glucuronolactone, creatine, L-theanine, Ginkgo Biloba, pantothenic acid, ginseng, caffeine, guarana, and/or taurine can also be added to the sweet potato liquid extracted from said sweet potato.

While certain preferred embodiments are shown in the figures and described in this disclosure, it is to be distinctly understood that the presently disclosed inventive concept(s) is not limited thereto but may be variously embodied to practice within the scope of the following claims. From the foregoing description, it will be apparent that various changes may be made without departing from the spirit and scope of the disclosure as defined by the following claims.

What is claimed is:

1. A method of juicing a sweet potato, wherein said method comprises the step of freezing a sweet potato by placing said sweet potato in sub freezing temperatures until said sweet potato is completely frozen, the step of thawing said sweet potato after freezing said sweet potato, and the step of extracting the liquid from said sweet potato immediately after said sweet potato has frozen completely, wherein said liquid is extracted by utilizing a juicer to extract the sweet potato juice and leaving sweet potato pulp.

2. The method of claim 1, wherein said sweet potato is kept at a temperature of less than 40 degrees Fahrenheit throughout the method, wherein said sweet potato liquid is kept at a temperature of less than 40 degrees Fahrenheit following said juicing process and at least until a step of bottling said sweet potato liquid.

3. The method of claim 1, wherein said method comprises the step of pasteurizing said sweet potato liquid.

4. The method of claim 1, wherein said method comprises juicing a plurality of sweet potatoes in batches, wherein said step of thawing a batch of sweet potatoes comprises thawing said first batch of sweet potatoes in the presence of a second batch of sweet potatoes prior to said second batch having been frozen causing the higher temperature of said second batch to thaw said first batch and thus cool said second batch of sweet potatoes.

5. The method of claim 1, wherein said method comprises the step of processing said sweet potato pulp for use as a human foodstuff.

6. The method of claim 1, wherein said method comprises the step of processing said sweet potato pulp for use as an animal foodstuff.

7. The method of claim 5, wherein said method comprises the step of dehydrating said sweet potato pulp.

8. The method of claim 1, wherein said method comprises the step of caffeinating the said sweet potato liquid.

9. The method of juicing a sweet potato of claim 8, wherein said method further comprises the step of adding at least one ingredient selected from the list consisting of vitamin B12, vitamin B6, Vitamin B3, and taurine to the sweet potato liquid extracted from said sweet potato.

10. The method of juicing a sweet potato of claim 1, wherein said method comprises the step of adding at least one ingredient selected from the group consisting of niacin, folic acid, riboflavin, cyanocobalamin, pyridoxine hydrochloride, L-carnitine, glucuronolactone, creatine, L-theanine, Ginkgo Biloba, pantothenic acid, ginseng, caffeine, guarana, and taurine to the sweet potato liquid extracted from said sweet potato.

11. The method of claim 6, wherein said step of processing said sweet potato pulp for a human foodstuff comprises seasoning said sweet potato pulp and packaging said sweet potato pulp as a product selected from the group consisting of hashbrowns and burger patties.

12. The method of claim 1, wherein method further comprises the step of treating said liquid extracted from said sweet potato by a process to reduce and/or eliminate pathogens in said sweet potato juice selected from the group consisting of ultra pasteurization and filtration.

13. The method of claim 4, wherein said step of thawing said first batch of sweet potatoes comprises separating said first batch of sweet potatoes and said second batch of sweet potatoes with a physical barrier configured to prevent pathogens from transferring from between said first and second batches of sweet potatoes, wherein said barrier is configured for thermal transfer between said first batch of sweet potatoes and said second batch of sweet potatoes.

14. The method of claim 1, wherein said sweet potato is juiced within 24-36 hours of placement into said temperatures sufficient for freezing said sweet potato.

15. The method of claim 1, wherein said sweet potato is removed from said freezing temperatures within one hour of freezing completely.
